(19) United States
(12) Patent Application Publication
(10) Pub. No.: US 2011/0143816 A1
(43) Pub. Date: Jun. 16, 2011

(54) PORTABLE DEVICE INCLUDING WARNING SYSTEM AND METHOD

(76) Inventor: Frank Fischer, Gomaringen (DE)

(21) Appl. No.: 12/993,384

(22) PCT Filed: Dec. 2, 2008
(86) PCT No.: PCT/EP2008/066608

§ 371 Date: Jan. 28, 2011

(30) Foreign Application Priority Data
Jun. 10, 2008 (DE) 102008002322.1

(51) Int. Cl. H04M 1/00

(52) U.S. Cl. 455/566

(57) ABSTRACT

A portable device for displaying information, in particular a mobile telephone, having a display for outputting image or text information, a detection system, and an output unit. The detection system is designed to detect an approach of the portable device to an object. The output unit may output a warning signal in the event of a predefined approach to the object, in particular a defined distance.

### FIELD OF THE INVENTION

The present invention relates to a portable device for displaying information and a method for outputting information.

BACKGROUND INFORMATION

In recent years, various supplemental functions such as SMS, game applications, pedestrian navigation, photography, video display and distance measurement have been developed for portable devices such as mobile telephones and other portable devices such as MP3 players, PDAs, and navigation devices.

One visible consequence is the ubiquitous presence and use of portable devices by pedestrians. Distraction caused by concentrating on the mobile application reduces the attention of pedestrians to traffic safety, resulting in an ever increasing occurrence of accidents.

### SUMMARY OF THE INVENTION

An object of the present invention is to provide an improved portable device for displaying information and an improved method for outputting information.

One advantage of the present invention is that the user of the portable device is warned when approaching an object. This is achieved by providing a detection system that detects when the portable device approaches an object and emits a signal. This increases the safety when the portable device is used.

The portable device may be, for example, a mobile telephone, a navigation device, a video device, or an MP3 player or a PDA.

Depending on the specific embodiment selected, a defined distance to an object or a collision course with reference to the object may be detected and used for the output of the warning signal.

An inertial sensor system may be used for detecting the movement. This makes it possible to use known systems for a precise detection of the movement and/or the direction of movement.

In another specific embodiment, the detection system has an ultrasonic, or an infrared, or a light or radar unit that may be used to measure the distance to an object.

In another specific embodiment, the detection system has a camera and an image evaluation unit that may be used to detect the approach to an object. This makes it possible to use a camera already integrated into, for example, a mobile telephone for additionally detecting an approach to an object. As a result, no additional costs arise.

In another specific embodiment, the detection system has a digital map and a positioning system. The digital map may be used to detect the position of objects and the relative position of the portable device in relation to the objects. This system may also be used to ascertain an approach to an object simply and precisely.

In another specific embodiment, the detection system has a step measuring system which may be used for measuring the steps of the user of the portable device and accordingly a movement of the portable device in a simple manner.

In another specific embodiment, the device is used for supporting a visually impaired person so that the warning of objects also improves the safety for the movement of the visually impaired person.

### BRIEF DESCRIPTION OF THE DRAWINGS

FIG. 1 shows a schematic representation of a portable device for outputting visual and/or acoustic information.

FIG. 2 shows a pedestrian using the portable device.

### DETAILED DESCRIPTION

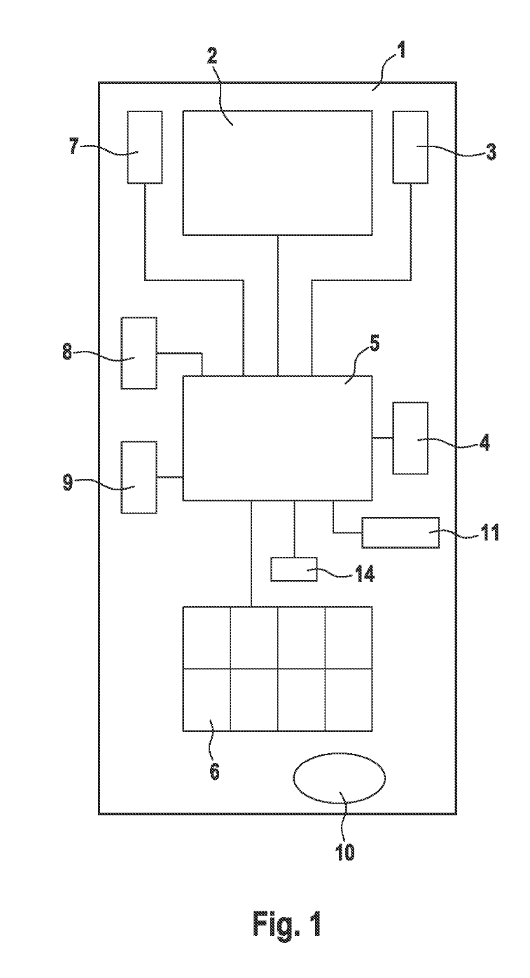

FIG. 1 shows a schematic representation of a portable device 1. The portable device is used for displaying and outputting visual and/or acoustic information. The portable device may be designed, for example, as a mobile telephone, an MP3 player, a PDA (personal digital assistant), a navigation device, a video device or a device for supporting a visually impaired person. Depending on the design, portable device 1 has the corresponding electrical and mechanical components of the design. For example, portable device 1 may have a display 2, a speaker 3, a data and program memory 4, a detection system 5, a keypad 6, a camera 7, an inertial sensor system 8, a distance measuring system 9, a speaker 10 and/or a vibration generator 11. Display 2 may be used for outputting video information, for example a computer game, an SMS text, navigation information, a photo, a video or distance measurement information. In addition, speaker 10 may be used for outputting acoustic information, for example music or a voice output.

Detection system 5 is used for detecting an approach of portable device 1 to an object, for example a building or a lamppost or a street or a vehicle. The approach may mean, for example, that the distance between an object and the portable device is below a predefined distance. This may be checked, for example, by using a distance measuring system 9. The distance measuring system may, for example, be designed as an ultrasonic, an infrared, a light or radar system which is used to detect the distance between portable device 1 and an object. If detection system 5 detects that the distance between portable device 1 and the object is smaller than a predefined distance, a warning signal, for example an acoustic and/or a visual and/or a vibration signal, is output using a vibration generator 11.

It is not absolutely necessary to determine the distance exactly. Furthermore, it may be sufficient that a critical surroundings situation is detected. Optical proximity switches, e.g., may be used for this purpose.

In another specific embodiment, detection system 5 has a camera 7 via which an image of the surroundings is recorded. Furthermore, in this specific embodiment, detection system 5 is connected to an image evaluation unit, via which it is possible to detect an approach to an object, for example a building, a street, a lamppost, a tree, another person or a car based on the image recorded using camera 7. To that end, the image evaluation unit is able to detect an object independently and also detect an approach based on the change in size of the object. An approach is understood to be both a predefined distance and a predefined collision course to an object. If detection system 5 detects that a collision course exists with respect to an object or the distance to the object is below a predefined distance, an acoustic, visual or vibration signal is output. A collision course is present if portable device 1 is moved in the direction of an object and the distance is below a predefined minimum distance.

For example, it is possible to use an inertial sensor system 8 for ascertaining the movement and the direction of movement of portable device 1. Inertial sensor system 8 is able to detect a direction of movement and a speed of movement or to determine if portable device 1 is used while walking (step detection).

In another specific embodiment, detection system 5 has a positioning system such as, for example, a GPS, which may be used to detect the position of the portable device and a direction of movement and a movement of portable device 1. In addition, a digital map may be stored in data and program memory 4, the map being used for correcting the position finding and/or for determining the positions of objects. For example, positions of streets and buildings are stored in the digital map, making it possible to detect the approach to a street or the approach to a building based on the data of the digital map and a reminder signal may draw attention to it as a warning.

In another specific embodiment, the detection system may have a step detection system which detects a movement of portable device 1 based on the user's steps. Frequently the reminder function is only of interest while walking.

The signals and measured values of the various specific embodiments of detection system 5 may be combined with one another as subsystems or as total systems in order to ascertain an approach to an object.

For example, data concerning objects of the digital map may be used to improve the determination of an approach using image detection. In addition, the data of the position-finding unit may be used to improve the position of portable device 1 under consideration of the signals of inertial sensor system 8. Furthermore, the data of the digital map may be combined with the signals of distance measuring system 9 to obtain more exact information concerning an approach to an object.

The described portable device is in particular suitable for providing an additional warning signal to persons having visual impairments if they approach an object, in particular if they approach an object at a specific distance or are on a collision course with the object.

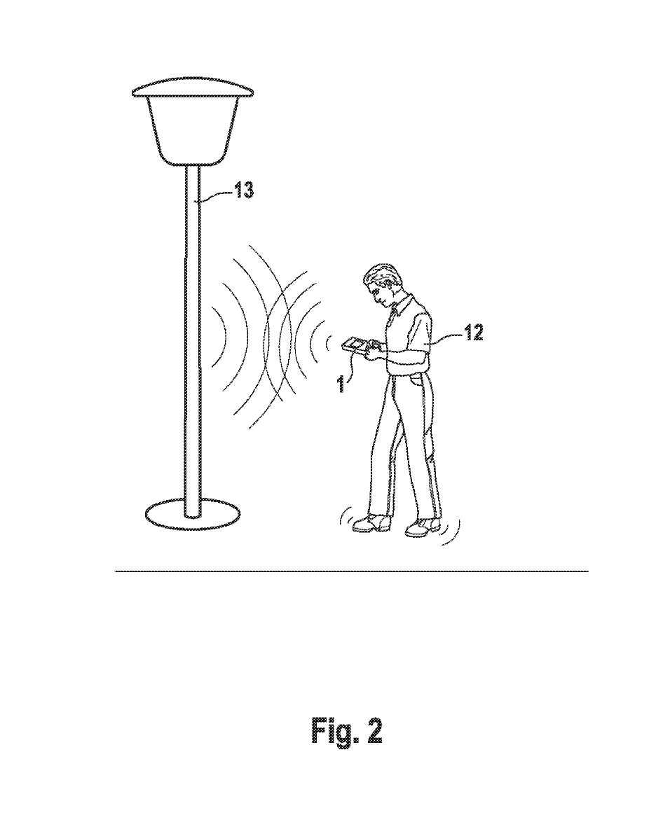

FIG. 2 shows a situation in which a person 12 carries a portable device 1, portable device 1 outputting acoustic and/or visual information. In addition, portable device 1 detects an approach to an object 13 which has the form of a lamppost. If the portable device using detection system 5 detects that person 12 approaches object 13 at a distance shorter than a predefined minimum distance, for example 1 meter, portable device 1 outputs an acoustic and/or a visual and/or a vibration signal. Moreover, the detection system may also ascertain a collision course in a direction to the object and, for example, if the distance is shorter than a minimum distance, output an acoustic, visual or vibrating warning signal. In this way, person 12 is warned against an undesired collision with object 13. This increases the safety for the operator of the portable device.

1-11. (canceled)

12. A portable device for displaying information, comprising:
a display for outputting image or text information; and
a detection system having an output unit, the detection system detecting an approach of the portable device to an object, the output unit outputting a signal in the event of a predefined approach to the object.

13. The device according to claim 12, wherein the portable device is a mobile telephone.

14. The device according claim 12, wherein the predefined approach includes a defined distance.

15. The device according to claim 12, wherein the portable device is a mobile telephone, a navigation device, a video device, an MP3 player, or a PDA.

16. The device according to claim 12, wherein the detection system detects a collision course between the portable device and the object as a predefined approach.

17. The device according to claim 12, wherein the detection system has an inertial sensor system for detecting at least one of a movement and a direction of movement of the device.

18. The device according to claim 12, wherein the detection system has an ultrasonic, an infrared, a light or a radar unit to measure a distance to the object.

19. The device according to claim 12, wherein the detection system has a camera and an image evaluation unit for detecting an approach to the object.

20. The device according to claim 12, wherein the detection system has a digital map and a positioning system, including a GPS system, the digital map and the positioning system being used for ascertaining an approach to an object or a location contained in the map.

21. The device according to claim 12, further comprising a memory including a digital map with positions of objects.

22. The device according to claim 12, wherein the detection system has a step measuring system for detecting a movement of a user.

23. The device according to claim 12, wherein the device is for supporting a visually impaired person.

24. A method for outputting at least one of acoustic information and visual information using a portable device, the method comprising:
using the portable device to monitor whether the portable device approaches an object; and
in the event of a predefined approach to the object, using the portable device to output a signal.

25. The method according to claim 24, wherein the method is for outputting an image or a text.
